(19) United States
(12) Patent Application Publication
(10) Pub. No.: US 2025/0174627 A1
(43) Pub. Date: May 29, 2025

(54) METHODS FOR PREPARING COMPOSITE CURRENT COLLECTORS WITH LOW ENERGY CONSUMPTION

(71) Applicant: JIANGYIN NANOPORE INNOVATIVE MATERIALS TECHNOLOGY LTD, Wuxi (CN)

(72) Inventors: Zhongya ZHU, Wuxi (CN); Jiandong LU, Wuxi (CN); Xuefa LI, Wuxi (CN); Guoping ZHANG, Wuxi (CN)

(21) Appl. No.: 18/833,392

(22) PCT Filed: Jan. 28, 2023
(86) PCT No.: PCT/CN2023/073530

§ 371 Date: Jul. 26, 2024

(30) Foreign Application Priority Data
Jan. 27, 2022 (CN) 202210102535.4
May 25, 2022 (WO) PCT/CN2022/094833

(51) Int. Cl. H01M 4/04; H01M 4/02; H01M 4/66

(52) U.S. Cl. CPC H01M 4/0452; H01M 4/044; H01M 4/664; H01M 4/666; H01M 4/667; H01M 2004/021

(57) ABSTRACT

The present disclosure relates to the technical field of new materials, and in particular, to a method for preparing a composite current collector. A specific amount of copper-containing photosensitive material and a high-molecular polymer are utilized together as materials of the surface layer of the composite current collector substrate. The composite current collector substrate is prepared through co-extrusion with a material of a core layer and materials of the surface layer. Under ultraviolet irradiation, a portion of divalent copper ions is reduced to elemental copper, forming a nanoscale copper layer. Simultaneously, another portion of the copper-containing photosensitive material is activated to create seed crystals with catalytic activity for chemical copper plating. The synergy between the nanoscale copper layer and seed crystals meets square resistance requirements for chemical plating or electroplating. This effectively replaces physical vapor deposition step in traditional processes, thereby reducing energy consumption and production costs while improving production efficiency. Additionally, a process of the ultraviolet irradiation treatment does not cause macroscopic damage to the high-molecular polymer, preserving its physical strength and performance and leading to enhanced product yield.

### CROSS-REFERENCE TO RELATED APPLICATIONS

The application claims priority to Chinese Patent Application No. 202210102535.4, filed on Jan. 27, 2022 with China National Intellectual Property Administration, entitled “METHODS FOR PREPARING COMPOSITE CURRENT COLLECTORS WITH LOW ENERGY CONSUMPTION”, and international patent application No. PCT/CN2022/094833, filed on May 25, 2022, entitled “METHODS FOR PREPARING COMPOSITE CURRENT COLLECTORS WITH LOW ENERGY CONSUMPTION”, the contents of which are hereby incorporated by reference in their entireties.

### TECHNICAL FIELD

The present disclosure relates to the technical field of new materials, and in particular, to a method for preparing a composite current collector.

### BACKGROUND

A composite current collector is an innovative material including metal plating on both sides of a polymer substrate, creating a “sandwich structure”. Currently, the method for preparing the composite current collector mainly involves using a physical vapor deposition method (PVD) to apply a metal layer of specific thickness to upper and lower surfaces of the polymer substrate within a vacuum environment. This process ensures that the metal layer achieves a necessary sheet resistance, meeting requirements for subsequent electroplating or chemical plating. Subsequently, the obtained polymer substrate is subjected to electroplating or electroless plating (chemical plating) on both sides to enhance the thickness of the metal layer, thereby achieving a required sheet resistance for use in secondary batteries.

However, the vacuum physical vapor deposition method demands sophisticated equipment and operates at high temperatures. This poses challenges as the polymer substrate is susceptible to issues such as deformation, wrinkling, foam channeling, perforation, and embrittlement under high temperatures. Even with real-time cooling during the deposition process, these problems persist. Consequently, the yield of produced composite current collectors through physical vapor deposition is typically below 50%. Furthermore, a slow deposition speed of physical vapor deposition leads to low production efficiency. The process also incurs high energy consumption as it involves metal gasification. The cooling of the polymer substrate further adds to energy requirements, resulting in substantial energy loss and hindering carbon reach and neutralization efforts.

### SUMMARY

The present disclosure provides a method for preparing a composite current collector with low energy consumption, low cost, high production efficiency and high yield.

In one aspect of the present disclosure, a method for preparing a composite current collector is provided herein, including the following steps:
providing a composite current collector substrate, the composite current collector substrate including a core layer and surface layers disposed on two sides of the core layer, respectively; performing an ultraviolet irradiation treatment on the surface layers to prepare an activated substrate; and performing an electroless copper plating (chemical copper plating) process on the activated substrate,
wherein a material of the core layer includes a first high-molecular polymer, and a material of the surface layers includes:
85 parts to 95 parts by mass of a second high-molecular polymer, and
10 parts to 20 parts by mass of a copper-containing photosensitive material.

In some embodiments, the copper-containing photosensitive material includes a first copper-containing photosensitive material and a second copper-containing photosensitive material. The first copper-containing photosensitive material is an inorganic metal oxide containing copper. The second copper-containing photosensitive material can be selected from: inorganic metal oxides containing copper, inorganic metal salts containing copper, and organometallic complexes containing copper. When the second copper-containing photosensitive material is an inorganic metal oxide containing copper, a material of the first copper-containing photosensitive material can be the same as or different from that of the second copper-containing photosensitive material. The inorganic metal oxide containing copper includes copper element and at least one metal element selected from cadmium, zinc, cobalt, magnesium, tin, titanium, iron, aluminum, nickel, gold, silver, palladium, manganese, and chromium. In the surface layer, the first copper-containing photosensitive material can be of 5 parts to 10 parts by mass, furthermore, 6 parts to 8 parts by mass. In the surface layer, the second copper-containing photosensitive material can be of 5 parts to 10 parts by mass, furthermore, 6 parts to 8 parts by mass. In some embodiments, a mass ratio of the first copper-containing photosensitive material to the second copper-containing photosensitive material is in a range of 1:2 to 2:1.

In some embodiments, the inorganic metal oxide containing copper is selected from copper dichromate, copper aluminate, copper manganate, copper ferrite, copper cobaltate, copper chromite black, copper iron manganite (CuFeMnO₄), copper iron cobaltate (CuFeCoO₄), and copper cobalt ferrite (CuCoFeO₄).

In some embodiments, the inorganic metal salt containing copper includes copper element and acidic group, the acidic group may be hydroxyl phosphate group, phosphate group, or thiocyanate group. In some embodiments, the inorganic metal salt containing copper is copper hydroxyphosphate.

In some embodiments, the organometallic complex containing copper is selected from copper-containing aromatic complexes, copper-containing alkenyl complexes, copper-containing metallocene complexes, copper-containing carbene complexes, and copper-containing carbyne complexes.

In some embodiments, a mass percentage of the copper-containing photosensitive material in the surface layer (i.e. (a mass part of the copper-containing photosensitive material)/(a mass part of the surface layer)*100%) is in a range of 8% to 20%.

In some embodiments, the material of the surface layer further includes 0.5 parts to 8 parts by mass of an additive, and the additive is selected from inorganic oxides, diphenyl diacetyl hydrazone compounds, dispersants, and an organic chelating agent;
wherein the diphenyl diacetyl hydrazone compound has the following structure:

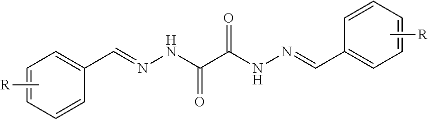

wherein R is each independently selected from —H, -D, —F, —Cl, —Br, substituted or unsubstituted C1-C6 alkyl, substituted or unsubstituted C1-C6 alkoxy, and substituted or unsubstituted phenyl, and
wherein the substituent can be one or more selected from halogen, hydroxyl, and carboxyl.

In some embodiments, the material of the surface layer comprises:
85 parts to 95 parts by mass of the second high-molecular polymer,
10 parts to 20 parts by mass of the copper-containing photosensitive material; and
0.5 parts to 8 parts by mass of the additive,
wherein a mass ratio of the first copper-containing photosensitive material to the second copper-containing photosensitive material is in a range of 1:2 to 2:1.

In some embodiments, the material of the surface layer comprises:
85 parts to 95 parts by mass of the second high-molecular polymer;
5 parts to 10 parts by mass of the first copper-containing photosensitive material;
5 parts to 10 parts by mass of the second copper-containing photosensitive material;
0.5 parts to 2 parts by mass of the inorganic oxide;
0.5 parts to 2 parts by mass of the diphenyl diacetyl hydrazone compound;
0.5 parts to 2 parts by mass of the dispersant; and
0.5 parts to 2 parts by mass of the organic chelating agent.

In some embodiments, the inorganic oxide is at least one selected from copper oxides, aluminum oxides, and silicon dioxides.

In some embodiments, in the structure of the diphenyl diacetyl hydrazone compound, R is —H, methyl, methoxy, ethyl, or ethoxy.

In some embodiments, the dispersant is at least one of diethyl acetamide, or polyethylene glycol.

In some embodiments, the organic chelating agent is at least one selected from Schiff base of salicylic acid, 1-hydroxyethylidene-1,1-diphosphonic acid, amino trimethylene phosphonic acid, and polyamino polyether tetramethylene phosphonic acid.

In some embodiments, in the ultraviolet irradiation treatment, a wavelength of an ultraviolet is in a range of 157 nm to 353 nm, preferably, in a range of 180 nm to 330 nm, more preferably, in a range of 200 nm to 300 nm.

In some embodiments, a time of the ultraviolet irradiation treatment is in a range of 5 ms to 100 ms, preferably, in a range of 20 ms to 80 ms, more preferably, in a range of 30 ms to 60 ms.

In some embodiments, the first high-molecular polymer and/or the second high-molecular polymer is at least one selected from polyethylene terephthalate, polyethylene, polypropylene, polyimide, polyether-ether-ketone, and polymethyl methacrylate.

In some embodiments, a thickness of the core layer is in a range of 1 μm to 2 μm.

In some embodiments, a thickness of a surface layer is in a range of 0.5 μm to 4.5 μm, and preferably, in a range of 1 μm to 3 μm.

In some embodiments, a thickness of the composite current collector substrate is in a range of 3 μm to 10 μm.

In some embodiments, a step of performing the electroless copper plating (chemical copper plating) process on the activated substrate includes performing an alkaline chemical copper plating process on the activated substrate to form a copper layer, wherein a thickness of the formed copper layer is in a range of 100 nm to 1000 nm, and preferably, in a range of 200 nm to 900 nm, more preferably, in a range of 400 nm to 800 nm.

In some embodiments, a step of performing the electroless copper plating (chemical copper plating) process on the activated substrate can employ any suitable electroless copper plating (chemical copper plating) solutions, for example, a composition which comprises 10 g/L to 15 g/L of copper sulfate, 0.08 g/L to 0.12 g/L of sodium pyrrolidine dithiocarbamate, 0.16 g/L to 0.24 g/L of benzyltriphenylphosphonium bromide, 0.24 g/L to 0.36 g/L of 2-(hydroxymethyl) thiophene, 18 g/L to 24 g/L of potassium sodium tartrate, 8 g/L to 12 g/L of EDTA (Ethylene Diamine Tetraacetic Acid), 0.008 g/L to 0.012 g/L of alpha-bipyridine, 0.02 g/L to 0.03 g/L of potassium ferrocyanide, and 2.5 g/L to 3.5 g/L of formaldehyde.

In some embodiments, the method further comprises performing a copper electroplating process after the step of performing the electroless copper plating (chemical copper plating) process. Performing the copper electroplating process includes performing an acidic electrolytic copper plating process to form an electroplated copper layer, and a thickness of the electroplated copper layer is in a range of 900 nm to 1100 nm. A copper electroplating solution is used in performing the acidic electrolytic copper plating process. The copper electroplating solution can be selected from any suitable electroplating solutions, such as copper sulfate electroplating solutions, including 80 ppm to 160 ppm copper sulfate, 80 ppm to 160 ppm sulfuric acid, 50 ppm to 70 ppm hydrochloric acid, 1 ppm to 5 ppm sodium polydithiodipropane sulfonate, and 10 ppm to 200 ppm polyethylene glycol 8000 (PEG 8000).

In some embodiments, the method further includes performing a chromium electroplating process to form a chromium layer after the step of performing the electroless copper plating (chemical copper plating) process or after performing the copper electroplating process. A thickness of the chromium layer is in a range of 1 nm to 2 nm.

A specific amount of copper-containing photosensitive material and a high-molecular polymer are utilized together as materials of the surface layer of the composite current collector substrate. The composite current collector substrate is prepared through co-extrusion with a material of a core layer and materials of the surface layers. Under ultraviolet irradiation, a portion of divalent copper ions is reduced to elemental copper, forming a nanoscale copper layer. Simultaneously, another portion of the copper-containing photosensitive material is activated to create seed crystals with catalytic activity for chemical copper plating. The synergy between the nanoscale copper layer and seed crystals not only meets square resistance requirements for chemical plating or electroplating, but also facilitates gradual crystallization and growth during subsequent chemical copper plating due to seed crystals within the substrate. This enhances the adhesion between chemical copper plating layer and the substrate, effectively replacing physical vapor deposition step in traditional processes, thereby reducing energy consumption and production costs while improving production efficiency. Additionally, a process of the ultraviolet irradiation treatment does not cause macroscopic damage to the high-molecular polymer, preserving its physical strength and performance and leading to enhanced product yield.

### BRIEF DESCRIPTION OF THE DRAWINGS

FIG. 1 is a cross-sectional structural diagram of a composite current collector according to an embodiment of the present disclosure.

### DETAILED DESCRIPTION

For ease of understanding the present disclosure, the present disclosure will be described more comprehensively hereinafter with reference to the accompanying drawings. Preferred embodiments of the present disclosure are given in the accompanying drawings. This application may, however, be embodied in many different forms and is not limited to the embodiments described herein. On the contrary, the purpose of providing these embodiments is to make the understanding of the disclosure of the present disclosure more thorough and comprehensive.

In addition, the terms “first” and “second” are used for descriptive purposes only and are not to be construed as indicating or implying relative importance or implicitly indicating the number of indicated technical features. Thus, the features defined with “first” and “second” may explicitly or implicitly include at least one of the features. In the description of the present disclosure, “a plurality of” means at least two, for example, two, three, etc. unless otherwise specifically defined. In the description of the present disclosure, “several” means at least one, for example, one or two, unless otherwise specifically defined.

Unless otherwise defined, all technical and scientific terms used herein have the same meaning as commonly understood by one of ordinary skill in the art to which the present disclosure belongs. The terms used herein in the specification of the present disclosure are only for the purpose of describing specific embodiments, and are not intended to limit the present disclosure. As used herein, the term “and/or” includes any and all combinations of one or more of the associated listed items.

In the present disclosure, in the technical feature of the open description, the closed technical solution including the recited features also includes the open technical solution including the recited features.

In the present disclosure, a numerical interval is involved, for example, unless otherwise specified, the numerical interval is regarded as continuous, and includes a minimum value and a maximum value of the range, and each value between the minimum value and the maximum value. Further, when the range refers to an integer, each integer between the minimum value and the maximum value of the range is included. In addition, the scope may be incorporated when a plurality of ranges are provided to describe features or characteristics. In other words, all ranges disclosed herein should be understood to include any and all sub-ranges subsumed therein unless otherwise indicated.

The percentage content involved in the present disclosure, for example, unless otherwise specified, refers to the mass percentage for solid-liquid mixing and solid-phase-solid-phase mixing, and the liquid-liquid phase mixing refers to the volume percentage.

The percentage concentration involved in the present disclosure, for example, unless otherwise specified, refers to the final concentration. The final concentration refers to the proportion of the additive component in the system after the component is added.

The temperature parameter in the present disclosure, for example, is not particularly limited, which not only allows for constant temperature processing, but also allows processing within a certain temperature range. The constant temperature process allows the temperature to fluctuate within the precision range of instrument control.

In one aspect of the present disclosure, a method for preparing a composite current collector is provided, which includes the following steps:
providing a composite current collector substrate, the composite current collector substrate including a core layer and surface layers disposed on two sides of the core layer, respectively; performing an ultraviolet irradiation treatment on the surface layer to prepare an activated substrate; and performing an electroless copper plating (chemical copper plating) process on the activated substrate,
wherein a material of the core layer includes a first high-molecular polymer, and a material of the surface layer includes:
85 parts to 95 parts by mass of a second high-molecular polymer, and
10 parts to 20 parts by mass of a copper-containing photosensitive material,
wherein the copper-containing photosensitive material includes a first copper-containing photosensitive material and a second copper-containing photosensitive material,
the first copper-containing photosensitive material is an inorganic metal oxide containing copper,
the second copper-containing photosensitive material is selected from inorganic metal oxides containing copper, inorganic metal salts containing copper, and organometallic complexes containing copper, and
the inorganic metal oxide containing copper comprises copper element and at least one metal element selected from cadmium, zinc, cobalt, magnesium, tin, titanium, iron, aluminum, nickel, gold, silver, palladium, manganese, and chromium.

In another aspect of the present disclosure, a material of a surface layer of a composite current collector substrate is provided, consisting of:
85 parts to 95 parts by mass of a second high-molecular polymer;
10 parts to 20 parts by mass of a copper-containing photosensitive material; and
0.5 parts to 8 parts by mass of an additive,
wherein the copper-containing photosensitive material includes a first copper-containing photosensitive material and a second copper-containing photosensitive material,
the first copper-containing photosensitive material is an inorganic metal oxide containing copper,
the second copper-containing photosensitive material is selected from inorganic metal oxides containing copper, inorganic metal salts containing copper, and organometallic complexes containing copper, and
the inorganic metal oxide containing copper comprises copper element and at least one metal element selected from cadmium, zinc, cobalt, magnesium, tin, titanium, iron, aluminum, nickel, gold, silver, palladium, manganese, and chromium.

In an embodiment, the additive of the surface layer of the composite current collector substrate is selected from inorganic oxides, diphenyl diacetyl hydrazone compounds, dispersants, and an organic chelating agent,
wherein the diphenyl diacetyl hydrazone compound has the following structure:

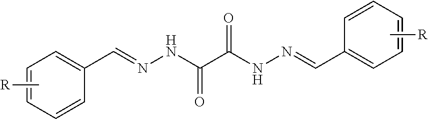

wherein R is each independently selected from —H, -D, —F, —Cl, —Br, substituted or unsubstituted C1-C6 alkyl, substituted or unsubstituted C1-C6 alkoxy, and substituted or unsubstituted phenyl, and
wherein the substituent is at least one selected from halogen, hydroxyl, and carboxyl.

Since the early 1990s, with the widespread commercial adoption of lithium-ion batteries, the specific energy density of these batteries has increased by approximately 3% per year. Alongside enhancing energy density, achieving lighter and safer lithium-ion batteries is crucial. Energy in lithium-ion batteries is primarily stored in the electrode material. Therefore, the conventional approach to enhance energy density involves optimizing and developing electrode materials or directly increasing the proportion of the active substance in the battery. However, altering these active components may lead to significant impact on battery performance, leading to complexity in operation and high research and development costs. To address this challenge, researchers have begun to deconstruct the battery's structure in search of innovative solutions. It has been observed that the traditional metal current collectors in batteries can take up 15% by weight of the batteries or even higher, which are primarily composed of metal foil films, heavy, and achieves single function. This component, serving as an electron conduction carrier, does not affect lithium ion transmission within the battery and offers significant potential for development. By optimizing the current collector, battery energy density can be further enhanced. This optimization has led to the emergence of a composite current collector with a “sandwich” structure. This collector features a lightweight polymer material as the support, with high-purity metal films layered on both sides of the polymer. As the organic polymer material are significantly lighter than metals, an overall thickness of the composite current collector remains unchanged (approximately 9 microns), making it lighter by up to 80% compared to the original pure metal current collector. With the reduced weight ratio of the current collector, battery energy density can be increased by 8% to 26% (specific figures vary based on battery types).

Copper, being a highly-conductive and cost-effective metal, is extensively utilized as a conductive material and is well-suited for preparing composite current collectors. However, elemental copper has a high boiling point of 2835 K. Consequently, if a copper-containing composite current collector is prepared via physical vapor deposition, despite copper's affordability; the stringent requirements of physical vapor deposition equipment and elevated temperatures result in high production costs. Moreover, achieving a specific sheet resistance necessitates the copper plating on the polymer's surface to possess a catalytic active center. In traditional methods, noble metals like silver or palladium are typically employed as catalytically active metals, further increasing production expenses.

In the present invention, a specific quantity of copper-containing photosensitive material (such as a combination of the first copper-containing photosensitive material, i.e., copper dichromate CuCr₂O₇ and the second copper-containing photosensitive material, i.e., copper hydroxyphosphate Cu₂(OH)PO₄) and a high-molecular polymer are utilized together as the materials of the surface layer for the composite current collector substrate. The composite current collector substrate is prepared through co-extrusion with material of the core layer and the material of the surface layers. Under ultraviolet irradiation, a portion of divalent copper ions is reduced to elemental copper, forming a nanoscale copper layer. Simultaneously, another portion of the copper-containing photosensitive material is activated to create seed crystals with chemical copper plating catalytic properties. The synergy between the nanoscale copper layer and the seed crystals is crucial. This synergy not only meets the required square resistance for chemical plating or electroplating but also the other part of the seed crystals facilitates gradual crystallization and growth during subsequent chemical copper plating while one part of the seed crystals maintains inside the substrate. This process enhances the adhesion between the electroless copper layer and the substrate, effectively replacing the physical vapor deposition step in traditional methods. This method eliminates the need for vacuum environments during deposition, minimizing cold and hot energy convection, reducing energy consumption, lowering production costs, and enhancing production efficiency. Furthermore, the nanoscale copper layer and the seed crystals have chemical copper plating catalytic activity. This reduces the reliance on precious metal catalysts like silver or palladium, thereby further reducing production costs. Additionally, the ultraviolet irradiation treatment does not cause macroscopic damage to the polymer material, preserving its physical strength and performance. Consequently, product yield is effectively enhanced.

In some embodiments, the material of the surface layer comprises, based on parts by mass:
88 parts to 92 parts by mass of the second high-molecular polymer;
6 parts to 8 parts by mass of the first copper-containing photosensitive material; and
6 parts to 8 parts by mass of the second copper-containing photosensitive material.

Furthermore, the material of the surface layer comprises:
90 parts by mass of the second high-molecular polymer;
7 parts by mass of the first copper-containing photosensitive material; and
7 parts by mass of the second copper-containing photosensitive material.

In the present disclosure, it has been observed that under ultraviolet radiation, the copper-containing photosensitive material (such as copper Cu₂(OH)PO₄ and copper dichromate CuCr₂O₇) can partially crystallize into a structure with a spinel configuration. This crystalline form can serve as a seed crystal for chemical copper plating, creating an environment conducive to copper plating on the surface of the high-molecular polymer. Consequently, this method obviates the need for the traditional method of depositing a copper layer via physical vapor deposition prior to copper plating. The amount of copper-containing photosensitive material (like copper hydroxyphosphate and copper dichromate) in the surface layer directly influences the subsequent formation of the nanoscale copper layer and the quality of chemical copper plating. A proper amount of copper-containing photosensitive materials not only brings the optimal chemical plating catalytic activity, but also has a strong bond between the resulting copper layer and the high-molecular polymer, preventing the formation of overly coarse grains that could compromise the compactness of the nanoscale copper layer or the chemical copper plating layer. Maintaining this balance ensures that the formed copper layer retains the necessary conductivity and physical strength.

In some embodiments, the material of the surface layer further includes 0.5 parts to 8 parts by mass of additives, and the additive is at least one selected from inorganic oxides, diphenyl diacetyl hydrazone compounds, dispersants, and an organic chelating agent.

The diphenyl diacetyl hydrazone compound has the following structure:

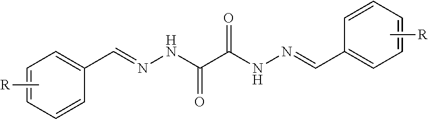

wherein R is each independently selected from —H, -D, —F, —Cl, —Br, substituted or unsubstituted C1-C6 alkyl, substituted or unsubstituted C1-C6 alkoxy, and substituted or unsubstituted phenyl, and
wherein the substituent is at least one selected from halogen, hydroxyl, and carboxyl.

In some embodiments, the material of the surface layer comprises:
85 parts to 95 parts by mass of the second high-molecular polymer;
5 parts to 10 parts by mass of the first copper-containing photosensitive material;
5 parts to 10 parts by mass of the second copper-containing photosensitive material;
0.5 parts to 2 parts by mass of the inorganic oxide;
0.5 parts to 2 parts by mass of the diphenyl diacetyl hydrazone compound;
0.5 parts to 2 parts by mass of the dispersant; and
0.5 parts to 2 parts by mass of the organic chelating agent.

Furthermore, the material of the surface layer comprises:
88 parts to 92 parts by mass of the second high-molecular polymer;
6 parts to 8 parts by mass of the first copper-containing photosensitive material;
6 parts to 8 parts by mass of the second copper-containing photosensitive material;
0.8 parts to 1.2 parts by mass of the inorganic oxide;
0.8 parts to 1.2 parts by mass of the diphenyl diacetyl hydrazone compound;
0.8 parts to 1.2 parts by mass of the dispersant; and
0.8 parts to 1.2 parts by mass of the organic chelating agent.

Furthermore, the material of the surface layer comprises:
90 parts by mass of the second high-molecular polymer;
7 parts by mass of the first copper-containing photosensitive material;
7 parts by mass of the second copper-containing photosensitive material;
1 part by mass of the inorganic oxide;
1 part by mass of the diphenyl diacetyl hydrazone compound;
1 part by mass of the dispersant; and
1 part by mass of the organic chelating agent.

In some embodiments, the inorganic oxide is at least one of copper oxide, aluminum oxide (alumina), or silicon dioxide (silica). An appropriate amount of the inorganic oxide can be incorporated to introduce micropores and achieve a suitable roughness in the surface layer, enhancing the bonding strength between the plating layer and the polymer material.

In some embodiments, R in the structure of the diphenyl diacetyl hydrazone compound is —H, methyl, methoxy, ethyl, or ethoxy. Furthermore, R is —H. The diphenyl diacetyl hydrazone compound having appropriate steric hindrance, and the microstructure of the copper-containing photosensitive material (such as copper hydroxyphosphate and copper dichromate) can be optimized to facilitate the growth of a superior crystal structure.

In some embodiments, the dispersant is at least one selected from diethyl acetamide and polyethylene glycol. Furthermore, the dispersant is diethyl acetamide.

In some embodiments, the organic chelating agent is at least one selected from Schiff base of salicylic acid, 1-hydroxyethylidene-1,1-diphosphonic acid (HEDP), amino trimethylene phosphonic acid (ATMP), and polyamino polyether tetramethylene phosphonic acid (PAPEMP). Furthermore, the organic chelating agent is Schiff base of salicylic acid. The organic chelating agent can be coordinated with copper and can also provide a certain steric hindrance, further optimizing the microstructure of copper hydroxyphosphate and copper dichromate.

In some embodiments, a wavelength of an ultraviolet of the ultraviolet irradiation treatment is in a range of 157 nm to 353 nm, and a time of the ultraviolet irradiation treatment is in a range of 5 ms to 100 ms. Alternatively, the wavelength of the ultraviolet of the ultraviolet irradiation treatment can be 160 nm, 165 nm, 170 nm, 175 nm, 180 nm, 185 nm, 190 nm, 195 nm, 200 nm, 220 nm, 240 nm, 260 nm, 280 nm, 300 nm, 320 nm, 340 nm, or 350 nm. Alternatively, the time of the ultraviolet irradiation treatment can be 10 ms, 20 ms, 30 ms, 40 ms, 50 ms, 60 ms, 70 ms, 80 ms, or 90 ms. Furthermore, the wavelength of the ultraviolet of the ultraviolet irradiation treatment can be in a range of 180 nm to 190 nm. The composite current collector substrate undergoes the ultraviolet irradiation treatment, so that a part of divalent copper ions can be reduced into elemental copper, and a nanoscale copper layer is formed on the surface of the substrate. Thereby, the surface of the polymer can reach the square resistance of electroplating or chemical plating, and meanwhile, a part of the copper-containing photosensitive material (such as copper hydroxyphosphate and copper dichromate) becomes a seed crystal with a spinel structure, which can eliminate the need for traditional steps involving physical vapor deposition and the use of noble metals like palladium or silver as catalysts, effectively reducing production costs and enhancing yields. Suitable ultraviolet wavelengths have suitable energy, and a rate of redox reaction of divalent copper and speed of crystal growth can be controlled within an appropriate range.

In some embodiments, the first high-molecular polymer and/or the second high-molecular polymer is at least one selected from polyethylene terephthalate, polyethylene, polypropylene, polyimide, polyether-ether-ketone, and polymethyl methacrylate. The core layer and the surface layers of the present disclosure may be prepared by co-extrusion, or may be separately prepared and then combined; and the preparation process may be various common film manufacturing processes in the art, for example, may be at least one of a blow molding process, a cast film process, or a biaxial stretching film preparation process.

In some embodiments, the core layer and/or the surface layer are prepared by a polymer solution, an intrinsic viscosity of the polymer solution is in a range of 0.5 dL/g to 0.8 dL/g. Optionally, the intrinsic viscosity of the polymer solution may be, for example, 0.6 dL/g or 0.7 dL/g. The polymer solution with such specific intrinsic viscosity may be more suitable for the method process of the present disclosure.

In some embodiments, a thickness of the core layer is in a range of 1 μm to 2 μm, and optionally, the thickness of the core layer may be, for example, 1.2 μm, 1.4 μm, 1.6 μm, or 1.8 μm.

In some embodiments, a thickness of the surface layer is in a range of 0.5 μm to 4.5 μm, optionally, the thickness of the surface layer may be, for example, 0.5 μm, 1.0 μm, 1.5 μm, 2.0 μm, 2.5 μm, 3.0 μm, 3.5 μm, 4.0 μm, or 4.5 μm. In some embodiments, the thickness of the surface layers on two sides of the core layer may be the same or different.

In some embodiments, a thickness of the composite current collector substrate is in a range of 3 μm to 10 μm. Optionally, a thickness of the composite current collector substrate may be, for example, 4 μm, 5 μm, 6 μm, 7 μm, 8 μm, or 9 μm.

The thickness of the core layer and/or the composite current collector substrate is limited within a specific range or a specific value, which can be particularly suitable for the preparation process of the present disclosure, so that the obtained composite current collector has better conductive performance, and the layers have higher bonding strength.

In some embodiments, a step of performing the electroless copper plating (chemical copper plating) process on the activated substrate includes performing an alkaline chemical copper plating process. A thickness of the copper layer obtained by electroless copper plating (chemical copper plating) process is in a range of 100 nm to 1000 nm. It can be understood that, before electroless copper plating (chemical copper plating) process, deionized water may be used to clean the activated substrate, which can avoid the influence on electroless copper plating process. The chemical copper plating process is mainly to form a thicker copper layer, so that a sheet resistance of the composite current collector can reach a standard value required by the secondary battery, and any conventional general alkaline chemical copper plating solution in the art can be used for copper plating. The thickness of the copper layer obtained by electroless copper plating can be adjusted as required, for example, 200 nm, 300 nm, 400 nm, 500 nm, 600 nm, 700 nm, 800 nm, or 900 nm.

In some embodiments, the method further includes performing a copper electroplating process after the step of performing the electroless copper plating process. Performing the copper electroplating process includes performing an acidic electrolytic copper plating process to form a copper layer, and a thickness of the copper layer is in a range of 900 nm to 1100 nm. Before the copper electroplating process, deionized water may be used to clean the activated substrate after performing the copper electroless plating process, which may avoid affecting the copper electroplating process. The copper electroplating process is mainly to further thicken the copper layer to meet the use requirements of the secondary battery, and any conventional general acidic electrolytic copper plating solution in the art can be used for copper plating. A thickness of the copper layer after performing the copper electroplating process can be adjusted as required, for example, 910 nm, 920 nm, 930 nm, 940 nm, 950 nm, 960 nm, 970 nm, 980 nm, 990 nm, 1000 nm, 1010 nm, 1020 nm, 1030 nm, 1040 nm, 1050 nm, 1060 nm, 1070 nm, 1080 nm, or 1090 nm.

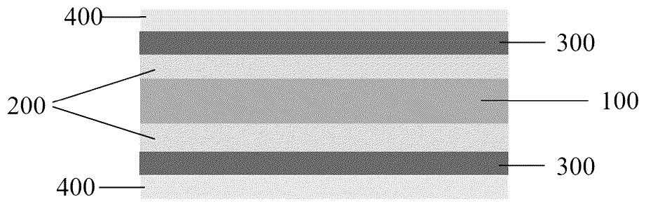

In an example, a structure of the composite current collector is shown in FIG. 1, two surface layers 200 are respectively located on two sides of the core layer 100, sides of the surface layers 200 away from the core layer 100 is further provided with copper plating layers 300 and 400, respectively. The copper plating layer 300 is prepared by an electroless copper plating (chemical copper plating) process, and the copper plating layer 400 is prepared by an electroplating process.

In some embodiments, the method further includes performing a chromium electroplating process to form a chromium layer after the step of performing the copper electroless plating process or the copper electroplating process. A thickness of the chromium layer is in a range of 1 nm to 2 nm. Before performing the chromium electroplating process, deionized water may be used to clean the activated substrate after performing the copper electroless plating process or the copper electroplating process, which may avoid affecting the chromium electroplating process. The chromium electroplating process is mainly to form an anti-oxidation protective layer to improve a service life of the composite current collector. A trivalent chromium or hexavalent chromium solution can be used for chromium plating.

In the preparation process of the composite current collector substrate, the steps of performing the copper electroplating process and performing the chromium electroplating process may be included at the same time, or either of the steps may be included. For example, when the steps of performing the copper electroplating process and performing the chromium electroplating process are included at the same time, the structure of the composite current collector is as follow: a polymer film layer, a copper electroplating layer, a copper electroplating layer, and a chromium electroplating layer in order. If only the chromium electroplating layer is included and the step of performing the copper electroplating process is not included, the composite current collector includes a polymer film layer—an electroless copper plating (chemical copper plating) layer—a chromium electroplating layer.

In some embodiments, after performing the electroless copper plating (chemical copper plating) process, performing the copper electroplating process or performing the chromium electroplating process, the method further includes a drying treatment. The drying treatment can be performed for 2 min to 5 min at a temperature ranged from 75° C. to 85° C. Furthermore, the drying treatment can be performed at 80° C. for 3 min.

The present disclosure is further described in detail below with reference to specific embodiments and comparative examples. For experimental parameters not written in the following specific embodiments, reference is made to the guidance given in this application in priority, and reference may also be made to experimental manuals in the art or other experimental methods known in the art, or reference to experimental conditions recommended by a manufacturer. It can be understood that the instruments and raw materials used in the following embodiments are more specific, and in other specific embodiments, the weight of the related components mentioned in the embodiments of the present disclosure may not only refer to the specific content of each component, but also may represent the proportional relationship between the weight among the components, so long as the content of the related components in the embodiments of the present disclosure is enlarged or reduced according to the embodiments of the specification of the present disclosure. Specifically, the weight described in the embodiments of the present disclosure may be a mass unit known in the chemical engineering fields such as μg, mg, g, kg, and the like.

### Example 1

### A Method for Preparing a Composite Current Collector is Provided.

Material of a core layer is polyethylene terephthalate (with intrinsic viscosity of 0.6 dL/g).

Material of a surface layer includes: 90 parts by mass of polyethylene terephthalate (with intrinsic viscosity of 0.6 dL/g), 7 parts by mass of Cu₂(OH)PO₄, 7 parts by mass of CuCr₂O₇, 1 part by mass of aluminum oxide (alumina), 1 part by mass of diphenyl diacetyl hydrazone compound (R is —H), 1 part by mass of diethyl acetamide, and 1 part by mass of Schiff base of salicylic acid.

According to the thickness of each layer, the amount of materials were calculated, and the material of the core layer and the material of the surface layer were supplied into a co-extrusion apparatus to prepare a polyethylene terephthalate substrate having a total thickness of 10 μm (wherein the core layer has a thickness of 2 μm), and an ultraviolet irradiation treatment was performed for 50 ms under ultraviolet light of 180 nm to obtain an activated polyethylene terephthalate substrate.

The activated polyethylene terephthalate substrate was washed with deionized water and then placed in an alkaline electroless copper plating solution (copper sulfate-formaldehyde system) for electroless copper plating. A thickness of a formed copper layer was 1000 nm. And the treated substrate was then taken out, washed with deionized water, and subsequently placed in an acidic copper electroplating solution (sulfuric acid-copper sulfate-chloride ion system) for copper electroplating (current density of 5 A/dm²), the copper layer was further thickened to 1000 nm. And the treated substrate was taken out, cleaned with deionized water, placed in a trivalent chromium electroplating solution for electroplating chromium (current density 30 A/dm²), forming an anti-oxidation chromium layer with a thickness of 2 nm and then dried at 80 degrees centigrade for 3 min to obtain a polyethylene terephthalate-copper composite current collector.

### Example 2

A method for preparing a composite current collector in Example 2 was substantially the same as the method of Example 1, the difference was in that a material of the surface layer included 92 parts by mass of polyethylene terephthalate, 6 parts by mass of Cu₂(OH)PO₄, 6 parts by mass of CuCr₂O₇, 1 part by mass of aluminum oxide, 1 part by mass of diphenyl diacetyl hydrazone compound (wherein R is —H), 1 part by mass of diethyl acetamide, and 1 part by mass of Schiff base of salicylic acid.

### Example 3

A method for preparing a composite current collector in Example 3 was substantially the same as the method of Example 1, the difference was in that a material of the surface layer included 85 parts by mass of polyethylene terephthalate, 10 parts by mass of Cu₂(OH)PO₄, 10 parts of CuCr₂O₇, 0.5 parts by mass of aluminum oxide, 0.5 parts by mass of diphenyl diacetyl hydrazone compound (wherein R is —H), 0.5 parts by mass of diethyl acetamide, and 0.5 parts by mass of Schiff base of salicylic acid.

### Example 4

A method for preparing a composite current collector in Example 4 was substantially the same as the method of Example 1, the difference was in that a material of the surface layer included 90 parts by mass of polyethylene terephthalate, 7 parts by mass of Cu₂(OH)PO₄, and 7 parts by mass of CuCr₂O₇.

### Example 5

A method for preparing a composite current collector in Example 5 was substantially the same as the method of Example 1, the difference was in that polyethylene terephthalate in the core layer and the surface layer was replaced with polypropylene having an intrinsic viscosity of 0.5 dL/g.

### Example 6

A method for preparing a composite current collector in Example 6 was substantially the same as the method of Example 1, the difference was in that polyethylene terephthalate in the core layer and the surface layer was replaced with polyimide having an intrinsic viscosity of 0.8 min dL/g.

### Example 7

A method for preparing a composite current collector in Example 7 was substantially the same as the method of Example 1, the difference was in that 7 parts by mass of Cu₂(OH)PO₄ and 7 parts by mass of CuCr₂O₇ in the material of the surface layer were replaced with 14 parts by mass of copper manganate.

### Example 8

A method for preparing a composite current collector in Example 8 was substantially the same as the method of Example 1, the difference was in that 7 parts by mass of Cu₂(OH)PO₄ and 7 parts by mass of CuCr₂O₇ in the material of the surface layer were replaced with 14 parts by mass of copper aluminate.

### Comparative Example 1

A method for preparing a composite current collector in Comparative Example 1 was substantially the same as the method of Example 1, the difference was in that 7 parts by mass of Cu₂(OH)PO₄ and 7 parts by mass of CuCr₂O₇ in the material of the surface layer were replaced with 14 parts by mass of Cu₂SO₄.

### Comparative Example 2

A method for preparing a composite current collector in Comparative Example 2 was substantially the same as the method of Example 1, the difference was in that the wavelength of the ultraviolet light was 100 nm.

The composite current collectors prepared in the examples and comparative examples were tested as follows, and the results were listed in Table 1.

### (1) Square Resistance Test

The test method: first, the prepared surface-flat composite current collector sample was placed on a sample table, and then a probe of a four-probe square resistance meter (DMR-1C) was in contact with the sample, and square resistance data was obtained on a display panel of the four-probe square resistance meter.

### (2) Tensile Strength and Elongation at Break Test

Test method: the composite current collector was cut into a sample bar with a length of 15 mm and a width of 200 mm, and then the sample bar was clamped in a tensile machine (Zwick ProLine), and the test was started with the parameters set as follows: the tensile speed was 50 mm/min, and the clamping distance was 100 mm. Each sample was tested 5 times in parallel, and an average value of the test results was taken as the final test result. In addition, each sample was divided into two sub-samples denoted as MD (sampled in a longitudinal direction) and TD (sampled in a transverse direction).

TABLE 1

| | Square | Elongation | Tensile Strength |
|---|---|---|---|
| Example | Resistance/mΩ | at Break/% | at break/MPa |
| Example 1 | 23 | MD 23 TD 9 | MD 150, TD 165 |
| Example 2 | 24 | MD 21 TD 7 | MD 145, TD 160 |
| Example 3 | 36 | MD 21 TD 6 | MD 145, TD 160 |
| Example 4 | 31 | MD 21 TD 7 | MD 145, TD 162 |
| Example 5 | 45 | MD 22 TD 8 | MD 145, TD 160 |
| Example 6 | 44 | MD 22 TD 8 | MD 145, TD 160 |
| Example 7 | 24 | MD 23 TD 9 | MD 144, TD 158 |
| Example 8 | 26 | MD 20 TD 6 | MD140, TD 150 |
| Comparative | 58 | MD 22 TD 8 | MD 135, TD 140 |
| Example 1 | | | |
| Comparative | 32 | MD 16 TD 5 | MD 108, TD 115 |
| Example 2 | | | |

It can be seen from Table 1 that the composite current collector prepared in the embodiments of the present disclosure has good conductivity and elongation at break, therefore, the composite current collector not only can play a basic conductive role, but also guarantees that the composite current collector is not easy to crack when subjected to external force impact or extrusion. The yield is significantly improved compared with that of the traditional technology. The preparation method is simple and low in energy consumption, and compared with a traditional physical vapor deposition method, the cost can be greatly reduced.

Compared with the optimal solution in Example 1, the material formula of the surface layer in Example 2 is not within the optimal range, and the amount of the polymer is slightly more, resulting in weak rise of the sheet resistance. Compared with Example 1, the amount of the polymer used in Example 3 is slightly less, resulting in a slight decrease in elongation at break. Compared with Example 1, no additive is included in Example 4, the bonding strength between the core layer and the surface layer is reduced, and the integrity is decreased, so the elongation at break is also slightly reduced. Compared with Example 1, copper sulfate in Comparative Example 1 is used to replace copper hydroxyphosphate and copper dichromate, since seed crystals cannot be formed, only a part of the copper ions are reduced to form a nanoscale copper layer, which is insufficient for chemical copper plating, so that the prepared composite current collector is very poor in conductivity, the bonding strength between the core layer and the surface layer is not too good, and therefore the elongation at break is also obviously reduced. Compared with Example 1, the wavelength of the ultraviolet light in Comparative Example 2 is too short, and the energy is too high, which leads to too fast growth of the nanoscale copper layer, coarse grains and loose structure, so the conductivity of the prepared composite current collector is also significantly reduced, and the elongation at break also decreases to a certain extent.

All technical features of the above embodiments can be combined in any way, for brevity, all possible combinations of the technical features in the above embodiments are not described; however, as long as no contradiction exists in the combination of these technical features, it should be considered as the scope of the present specification.

The above-mentioned embodiments only express several embodiments of the present disclosure, and the description thereof is more specific and detailed, but it cannot be understood as a limitation on the scope of the invention. It should be noted that, for a person of ordinary skill in the art, several variations and improvements may also be made without departing from the concept of the present disclosure, which all fall within the protection scope of the present disclosure. Therefore, the protection scope of this application shall be subject to the appended claims, and the specification and the accompanying drawings may be used to explain the content of the claims.

1. A method for preparing a composite current collector, comprising the following steps:
providing a composite current collector substrate, the composite current collector substrate comprising a core layer and surface layers disposed on two sides of the core layer, respectively; performing an ultraviolet irradiation treatment on the surface layers to prepare an activated substrate; and performing an electroless copper plating process on the activated substrate,
wherein the material of the core layer comprises a first high-molecular polymer, and the material of the surface layers comprises:
85 parts to 95 parts by mass of a second high-molecular polymer, and
10 parts to 20 parts by mass of a copper-containing photosensitive material,
wherein the copper-containing photosensitive material comprises a first copper-containing photosensitive material and a second copper-containing photosensitive material,
the first copper-containing photosensitive material is an inorganic metal oxide containing copper,
the second copper-containing photosensitive material is at least one selected from inorganic metal oxides containing copper, inorganic metal salts containing copper, and organometallic complexes containing copper, and
the inorganic metal oxide containing copper comprises copper element and at least one metal element selected from cadmium, zinc, cobalt, magnesium, tin, titanium, iron, aluminum, nickel, gold, silver, palladium, manganese, and chromium.

2. The method of claim 1, wherein the material of the surface layer further comprises 0.5 parts to 8 parts by mass of an additive, and the additive is at least one selected from inorganic oxides, diphenyl diacetyl hydrazone compounds, dispersants, and organic chelating agents,
wherein the diphenyl diacetyl hydrazone compound has the following structure: 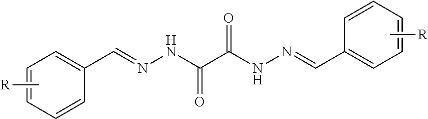
wherein R is each independently selected from —H, -D, —F, —Cl, —Br, substituted or unsubstituted C1-C6 alkyl, substituted or unsubstituted C1-C6 alkoxy, and substituted or unsubstituted phenyl, and
wherein the substituent is at least one selected from halogen, hydroxyl, and carboxyl.

3. The method of claim 1, wherein the method meets at least one of conditions (1) and (2):
(1) the inorganic metal salts containing copper comprise copper element and an acidic group, the acidic group is selected from hydroxyl phosphate group, phosphate group, and thiocyanate group;
(2) the organometallic complexes containing copper are selected from copper-containing aromatic complexes, copper-containing alkenyl complexes, copper-containing metallocene complexes, copper-containing carbene complexes, and copper-containing carbyne complexes.

4. The method of claim 2, wherein the material of the surface layers comprises:
85 parts to 95 parts by mass of the second high-molecular polymer,
10 parts to 20 parts by mass of the copper-containing photosensitive material; and
0.5 parts to 8 parts by mass of the additive,
wherein the mass ratio of the first copper-containing photosensitive material to the second copper-containing photosensitive material is in a range of 1:2 to 2:1.

5. The method of claim 2, wherein the material of the surface layers comprises:
85 parts to 95 parts by mass of the second high-molecular polymer;
5 parts to 10 parts by mass of the first copper-containing photosensitive material;
5 parts to 10 parts by mass of the second copper-containing photosensitive material;
0. 5 parts to 2 parts by mass of the inorganic oxide;
0. 5 parts to 2 parts by mass of the diphenyl diacetyl hydrazone compound;
0. 5 parts to 2 parts by mass of the dispersant; and
0.5 parts to 2 parts by mass of the organic chelating agent.

6. The method of claim 4, wherein the first copper-containing photosensitive material is CuCr₂O₇, and the second copper-containing photosensitive material is Cu₂(OH)PO₄.

7. The method of claim 2, wherein the method meets at least one of conditions (1), (2), (3), and (4):
(1) the inorganic oxide is at least one selected from copper oxide, aluminum oxide, and silicon dioxide;
(2) in the structure of the diphenyl diacetyl hydrazone compounds, R is —H, methyl, methoxy, ethyl, or ethoxy;
(3) the dispersant is at least one selected from diethyl acetamide and polyethylene glycol;
(4) the organic chelating agent is at least one selected from Schiff base of salicylic acid, 1-hydroxyethylidene-1,1-diphosphonic acid, amino trimethylene phosphonic acid, and polyamino polyether tetramethylene phosphonic acid.

8. The method of claim 1, wherein in the ultraviolet irradiation treatment, a wavelength of an ultraviolet is in a range of 157 nm to 353 nm, and a time of the ultraviolet irradiation treatment is in a range of 5 ms to 100 ms.

9. The method of claim 1, wherein the method meets at least one of conditions (1) and (2):
(1) the first high-molecular polymer is at least one selected from polyethylene terephthalate, polyethylene, polypropylene, polyimide, polyether-ether-ketone, and polymethyl methacrylate;
(2) the second high-molecular polymer is at least one selected from polyethylene terephthalate, polyethylene, polypropylene, polyimide, polyether-ether-ketone, and polymethyl methacrylate.

10. The method of claim 1, wherein the method meets at least one of conditions (1) and (2):
(1) the thickness of the core layer is in a range of 1 μm to 2 μm;
(2) the thickness of the composite current collector substrate is in a range of 3 μm to 10 μm.

11. The method of claim 1, wherein a step of performing the electroless copper plating process on the activated substrate comprises performing an alkaline chemical copper plating process on the activated substrate to form a copper layer, wherein the thickness of the chemical plated copper layer is in a range of 100 nm to 1000 nm.

12. The method of claim 1, further comprising performing a copper electroplating process after the step of performing the electroless copper plating process, wherein performing the copper electroplating process comprises performing an acidic electrolytic copper plating process to form a copper layer, and the thickness of the electroplated copper layer is in a range of 900 nm to 1100 nm.

13. The method of claim 1, further comprising performing a chromium electroplating process to form a chromium layer after the step of performing the electroless copper plating process, wherein the thickness of the chromium layer is in a range of 1 nm to 2 nm.

14. The method of claim 12, further comprising performing a chromium electroplating process to form a chromium layer after the step of performing the copper electroplating process, wherein the thickness of the chromium layer is in a range of 1 nm to 2 nm.

15. The method of claim 1, wherein the thickness of the surface layer is in a range of 0.5 μm to 4.5 μm.

16. A material of a surface layer of a composite current collector substrate, comprising:
85 parts to 95 parts by mass of a second high-molecular polymer;
10 parts to 20 parts by mass of a copper-containing photosensitive material; and
0.5 parts to 8 parts by mass of an additive,
wherein the copper-containing photosensitive material comprises a first copper-containing photosensitive material and a second copper-containing photosensitive material,
the first copper-containing photosensitive material is an inorganic metal oxide containing copper,
the second copper-containing photosensitive material is at least one selected from inorganic metal oxides containing copper, inorganic metal salts containing copper, and organometallic complexes containing copper, and
the inorganic metal oxides containing copper comprise copper element and at least one metal element selected from cadmium, zinc, cobalt, magnesium, tin, titanium, iron, aluminum, nickel, gold, silver, palladium, manganese, and chromium.

17. The material of the surface layer of the composite current collector of claim 16, wherein the additive is at least one selected from inorganic oxides, diphenyl diacetyl hydrazone compounds, dispersants, and organic chelating agents,
wherein the diphenyl diacetyl hydrazone compound has the following structure: 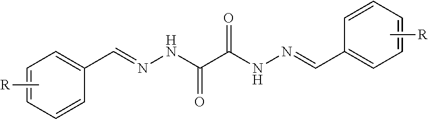
wherein R is each independently selected from —H, -D, —F, —Cl, —Br, substituted or unsubstituted C1-C6 alkyl, substituted or unsubstituted C1-C6 alkoxy, and substituted or unsubstituted phenyl, and
wherein the substituent is at least one selected from halogen, hydroxyl, and carboxyl.
